(19) United States
(12) Patent Application Publication
(10) Pub. No.: US 2007/0054091 A1
(43) Pub. Date: Mar. 8, 2007

(54) Label for in-mold molding and resin container decorated with the same

(75) Inventors: Yasuo Iwasa, Ibaraki (JP); Masaki Shiina, Ibaraki (JP); Takatoshi Nishizawa, Ibaraki (JP)

Correspondence Address: SUGHRUE-265550, 2100 PENNSYLVANIA AVE. NW, WASHINGTON, DC, 20037-3213, US

(73) Assignee: YUPO CORPORATION

(21) Appl. No.: 11/217,414

(22) Filed: Sep. 2, 2005

(51) Int. Cl. B32B 1/08; B32B 3/10

(52) U.S. Cl. 428/136; 428/35.7

(57) ABSTRACT

A label for in-mold molding having a porosity of 10% or less and an opacity (in conformity with JIS-P-8138) of 20% or less, and comprising a thermoplastic resin film base layer (I) and a heat sealable resin layer (II), wherein the heat sealable resin layer (II) has the degree of a non-crystallinity of from 60 to 90% measured with a differential scanning calorimeter (DSC) at less than 90° C., and contains a copolymer of propylene and α-olefin having from 4 to 20 carbon atoms, and a labeled container having the same.

### FIELD OF THE INVENTION

The present invention relates to a label for use in in-mold molding in which the label is initially set in a mold so that the side of the label that is in contact with the mold wall surface contains printed matter, and a parison of a molten thermoplastic resin is introduced into the mold and molded by blow molding, or a molten thermoplastic resin is molded by injection molding, or a molten thermoplastic resin sheet is molded in the mold by vacuum forming or air pressure forming to thereby produce a labeled resin container; a resin container with the label; a producing method of the label; and a producing method of the labeled resin container.

### BACKGROUND OF THE INVENTION

A conventional integral molding process for producing a labeled resin container comprises initially inserting a blank or a label in a mold and then molding a container by injection molding, blow molding, differential pressure forming, foaming molding, etc., to decorate the container within the mold [see JP-A-58-69015 (the term “JP-A” as used herein means an “unexamined published Japanese patent application”), and EP-A-254,923]. Such known in-mold labels include gravure printed resin films, multicolor offset printed synthetic papers [see JP-B-2-7814 (the term “JP-B” as used herein means an “examined Japanese patent publication”), and JP-A-2-84319], and gravure printed aluminum labels comprising an aluminum foil laminated on the back side thereof with high pressure low density polyethylene and an ethylene/vinyl acetate copolymer.

However, conventional processes for producing labeled containers by in-mold molding have the following drawbacks. Porous opaque labels show satisfactory adhesion to containers due to thermal insulating effect on condition of the low cooling temperature of the mold, but non-porous transparent labels are high in heat conduction and rapidly cool, so that heat sealable resins are not melted, which results in low adhesion of the labels and the containers and the labels are liable to peel off the containers. Transparent labels employing, as the heat sealable resin, a branched or straight chain low density polyethylene, an ethylene/vinyl acetate copolymer or an ethylene/acrylic acid copolymer show relatively good adhesion to containers when the containers are made of polyethylene, however, in the case of containers made of polypropylene that is more transparent than polyethylene, adhesion of the labels to the containers is conspicuously low and the labels easily peel off the containers, and accompanied by the occurrence of many blisters during production, so that the rate of loss of the containers is high. A transparent container, e.g., polypropylene, is extending the market as the amount and the state of the content can be confirmed. With such a tendency, the switchover of opaque labels to transparent ones is contrived so that the contents of containers can be seen.

To cope with the aforementioned prior art drawbacks, JP-9-207166 proposes an in-mold label mainly comprising, as a heat sealable resin, an ethylene/α-olefin copolymer obtained by copolymerizing from 40 to 98 wt % of ethylene and from 60 to 2 wt % of α-olefin having from 3 to 30 carbon atoms with a metallocene catalyst. However, even with the in-mold label, adhesion is low and the label is liable to peel off containers, or many blisters occur when the cooling temperature of the mold is low in the in-mold molding.

Further, when an ethylene/vinyl acetate copolymer or an ethylene/acrylic acid copolymer having a low melting point is used as the heat sealable resin of an in-mold label, the label shows relatively good adhesion to polypropylene containers, but there are another problem of hot fill such that the label easily peels off the containers or gets out of position when the temperature of the contents filled in the containers is 90° C. or so.

### SUMMARY OF THE INVENTION

An object of the present invention is to provide a label for use in in-mold molding that is free from the occurrence of blisters on low temperature cooling condition of a mold, and also shows high adhesion to a container filled with high temperature contents.

The present invention has the following constitutions.

1. A label for in-mold molding, having a porosity of 10% or less and an opacity (in conformity with JIS-P-8138) of 20% or less, and comprising a thermoplastic resin film base layer (I) and a heat sealable resin layer (II), wherein the heat sealable resin layer (II) has the degree of a non-crystallinity of from 60 to 90% measured with a differential scanning calorimeter (DSC) at less than 90° C., and contains a copolymer of propylene and α-olefin having from 4 to 20 carbon atoms.

2. The label for in-mold molding as described in the above item 1, wherein the heat sealable resin layer (II) has the degree of a non-crystallinity of from 65 to 90% measured with a DSC at less than 90° C.

3. The label for in-mold molding as described in the above item 1, wherein a material of a container as an adherend contains a polyolefin resin.

4. The label for in-mold molding as described in the above item 3, wherein the polyolefin resin is a polypropylene resin.

5. The label for in-mold molding as described in the above item 1, which comprises the heat sealable resin layer (II) on one side of the thermoplastic resin film base layer (I), and is labeled on a container through the heat sealable resin layer (II).

6. The label for in-mold molding as described in the above item 5, wherein the thermoplastic resin film base layer (I) is a monoaxially stretched layer.

7. The label for in-mold molding as described in the above item 5, wherein the thermoplastic resin film base layer (I) is a biaxially stretched layer.

8. The label for in-mold molding as described in the above item 5, wherein the thermoplastic resin film base layer (I) comprises a biaxially stretched layer and a monoaxially stretched layer.

9. The label for in-mold molding as described in the above item 5, wherein the heat sealable resin layer (II) is a layer that is at least a monoaxially stretched.

10. The label for in-mold molding as described in the above item 5, wherein the heat sealable resin layer (II) is embossed.

11. The label for in-mold molding as described in the above item 5, wherein the heat sealable resin layer (II) is formed by coating.

12. The label for in-mold molding as described in the above item 5, wherein a peel-off and misalignment of the label do not occur when a container with the label is filled with a content of 90° C.

13. The label for in-mold molding as described in the above item 1, which has at least one of holes and slits.

14. A labeled resin container, which is labeled with the label for in-mold molding as described in the above item 1.

15. The labeled resin container as described in the above item 14, which is a polypropylene resin container.

16. A method for producing the label for in-mold molding as described in the above item 1.

17. A method for producing the labeled resin container as described in the above item 14.

### DETAILED DESCRIPTION OF THE INVENTION

The in-mold label of the present invention is described in detail below.

Thermoplastic Resin Film Base Layer (I):

The thermoplastic resin film base layer (I) for use in the invention is a layer containing at least a thermoplastic resin. The examples of thermoplastic resins for use in the base layer (I) include the films of polyolefin resins, e.g., propylene resin, high density polyethylene, medium density polyethylene, polymethyl-1-pentene, an ethylene/cyclic olefin copolymer, etc.; polyamide resins, e.g., polyethylene terephthalate resin, polyvinyl chloride resin, nylon-6, nylon-6,6, nylon-6,10, nylon-6,12, etc.; ABS resins and ionomer resins. Preferred of these resins are thermoplastic resins having a melting point of from 130 to 280° C. such as propylene resin, high density polyethylene and polyethylene terephthalate resin, and these resins can also be used as mixture of two or more kinds.

It is preferred for the main component of thermoplastic resins to have a melting point lower than that of the polyolefin resin constituting the heat sealable resin layer (II) by 15° C. or more. Of such resins, propylene resins are preferred for their chemical resistance and in the point of costs. As such propylene resins, propylene homopolymers showing isotactic or syndiotactic stereoregularity, and copolymers comprising propylene as the main component with α-olefins, e.g., ethylene, butene-1, hexene-1, heptene-1,4-methylpentene-1, etc., are used. These copolymers may be binary, ternary, or quaternary, and may be random copolymers or block copolymers.

It is preferred to compound inorganic and/or organic fillers to the thermoplastic resin film base layer (I) besides thermoplastic resins. As the inorganic fine powders, composite inorganic fine powders having aluminum oxide or hydroxide around the nuclei of hydroxyl group-containing inorganic fine powders, e.g., heavy calcium carbonate, precipitated calcium carbonate, calcined clay, talc, barium sulfate, diatomaceous earth, magnesium oxide, zinc oxide, titanium oxide, silicon oxide, and silica, and hollow glass beads are exemplified. The surface-treated products of these inorganic fine powders treated with various surface treating agents can also be used. Heavy calcium carbonate, calcined clay and talc are preferred for inexpensiveness and molding property, and heavy calcium carbonate is especially preferred.

The examples of organic fillers include polymers and copolymers of polyethylene terephthalate, polybutylene terephthalate, polyamide, polycarbonate, polyethylene naphthalate, polystyrene, acrylic ester and methacrylic ester, homopolymers of melamine resin, polyethylene sulfite, polyimide, polyethyl ether ketone, polyphenylene sulfite, and cyclic olefin, and copolymers of cyclic olefin and ethylene. It is particularly preferred to use resins having a higher melting point than the melting point of the thermoplastic resin to be used and incompatible with the thermoplastic resin. When olefin resins are used, they are preferably selected from homopolymers of polyethylene terephthalate, polybutylene terephthalate, polyamide, polycarbonate, polyethylene naphthalate, polystyrene and cyclic olefin, and copolymers of cyclic olefin and ethylene.

Of these inorganic fine powders and organic fillers, inorganic fine powders are more preferred from the viewpoint that the generating quantity of heat in burning is little.

The average particle size of the inorganic fine powders or the average dispersion particle size of the organic fillers for use in the present invention is preferably from 0.01 to 30 μm, more preferably from 0.1 to 20 μm, and still more preferably from 0.5 to 15 μm. The average particle size is preferably 0.1 μm or more for easiness of mixture with thermoplastic resins. In the case of generating voids in the inside of thermoplastic resins by stretching to improve printability, the average particle size is preferably 20 μm or less so as to hardly bring about breaking of the sheet in stretching and strength reduction of the surface layer.

The average particle size of the inorganic fine powders for use in the present invention can be determined, as an example, by the particle sizes corresponding to particles of 50% in accumulation (cumulative 50% particle size) measured with a particle measuring apparatus, e.g., a laser analyzing particle measuring apparatus “Microtrac” (trade name, a product of Nikkiso Co., Ltd.) . The particle size of organic filler dispersed in a thermoplastic resin by melt kneading and dispersing can also be found by measuring at least 10 particles from the cross-section of the label with an electron microscope and taking as the average value of these particle sizes.

One kind of filler selected from the above fillers may be used alone in the in-mold label in the invention, or two or more kinds may be used in combination. When two or more kinds are used in combination, inorganic fine powders and organic fillers may be combined.

In blending and kneading these fine powders/fillers with a thermoplastic resin, if necessary, an antioxidant, a UV stabilizer, a dispersant, a lubricant, a compatibilizing agent, a flame retardant and a coloring pigment may be added. For using the in-mold label in the invention as a durable material, it is preferred to use an antioxidant and a UV stabilizer together. An antioxidant is generally added in an amount of from 0.001 to 1 wt %. Specifically, steric hindrance phenol, phosphorus and amine stabilizers can be used. A UV stabilizer is generally added in an amount of from 0.001 to 1 wt %. Specifically, optical stabilizers, e.g., steric hindrance amine, benzotriazole and benzophenone can be used.

A dispersant and a lubricant are used for the purpose of dispersing inorganic fine powders. The use amount of a dispersant and a lubricant is generally from 0.01 to 4 wt %. Specifically, a silane coupling agent, a higher fatty acid, e.g., oleic acid and stearic acid, metallic soap, polyacrylic acid, polymethacrylic acid and salts thereof can be used. Further, when organic filler is used, the kind and the addition amount of a compatibilizing agent are important, since these factors determine the particle form of the organic filler. As the preferred compatibilizing agents for organic fillers, epoxy-modified polyolefin and maleic acid-modified polyolefin are exemplified. The addition amount of a compatibilizing agent is preferably from 0.05 to 10 weight parts per 100 weight parts of the organic filler.

When transparency is required of a label for making the colors of a container noticeable, the thermoplastic resin film base layers (I) as described below are preferred. That is, the preferred examples of the base layers (I) include a stretched resin film comprising a biaxially stretched film core layer (A) of the resin composition containing in proportion of from 0 to 5 wt % of inorganic fine powder, from 0 to 20 wt % of high density polyethylene, and from 100 to 75 wt % of propylene resin, a monoaxially stretched film surface layer (B) of the resin composition containing in proportion of from 1 to 30 wt % of inorganic fine powder, from 0 to 10 wt % of high density polyethylene, and from 99 to 60 wt % of propylene resin, and a monoaxially stretched film back surface layer (C) of the resin composition containing in proportion of from 1 to 30 wt % of inorganic fine powder, from 0 to 10 wt % of high density polyethylene, and from 99 to 60 wt % of propylene resin, and the surface layer (B) is laminated on one side of the core layer (A), and the back surface layer (C) is laminated on the core layer (A) on the side opposite to the surface layer (B); and a stretched resin film comprising a monoaxially stretched film core layer (A) of the resin composition containing in proportion of from 0 to 5 wt % of inorganic fine powder, from 0 to 20 wt % of high density polyethylene, and from 100 to 75 wt % of propylene resin, and a monoaxially stretched film surface layer (B) of the resin composition containing in proportion of from 1 to 30 wt % of inorganic fine powder, from 0 to 10 wt % of high density polyethylene, and from 99 to 60 wt % of propylene resin laminated on one side of the core layer (A).

In these stretched resin film base layers (I), printed matter is formed on the surface layer (B) side and a heat sealable resin layer (II) is formed on the side of the core layer (A) or the back surface layer (C). The density of the thermoplastic resin film base layer (I) is preferably in the range of from 0.85 to 1.02 g/cm³. The thickness of the thermoplastic resin film base layer (I) is in the range of from 20 to 250 μm, preferably from 40 to 200 μm. If the thickness is less than 20 μm, insertion of a label into a mold with a label inserter is not effected and the label is not inserted to the proper position or the label is wrinkled, while when the thickness exceeds 250 μm, the strength at the boundary between the in-mold molded container and the label reduces, so that the falling resisting strength of the container decreases. As the thickness of each layer, layer (A) is preferably from 19 to 170 μm (more preferably from 38 to 130 μm), layer (B) is preferably from 1 to 40 μm (more preferably from 2 to 35 μm), and layer (C) is preferably from 0 to 40 μm (more preferably from 0 to 35 μm).

Heat Sealable Resin Layer (II):

The heat sealable resin layer (II) has the degree of a non-crystallinity of from 60 to 90% measured with a DSC at less than 90° C., and contains a copolymer of propylene and α-olefin having from 4 to 20 carbon atoms (an α-olefin resin).

The degree of a non-crystallinity measured with a DSC at less than 90° C. is preferably 90% or more, more preferably from 65 to 90%, and still more preferably from 70 to 88%. If the degree of a non-crystallinity is less than 60%, the adhesion property of the label deteriorates and peeling of label and blister are liable to occur, while when it exceeds 90%, hot fill suitability is liable to deteriorate. The heat sealable resin can contain polyolefin wax, a tackiness imparting resin, and polyolefin resins that can be used in the thermoplastic resin film base layer (I). When the heat sealable resin contains various kinds of thermoplastic resins, the main component (the most in weight) is preferably an α-olefin resin having from 4 to 20 carbon atoms.

The degree of a non-crystallinity at less than 90° C. in the present invention is a value found according to the following equation (1).
The degree of a non-crystallinity at less than 90° C. (%)=100−(the quantity of heat of fusion at 90° C. or more)/(the quantity of heat of fusion of a 100% crystal state) (1)

As the quantity of heat of fusion of a propylene resin in a 100% crystal state, the value of 209 J/g (J. Appl. Polym. Sci., 87, 916, 2003) was quoted, and as the quantity of heat of fusion of an ethylene resin, the value of 277 J/g (Polymer Handbook, Vo. 13, Fourth Edition) was quoted.

α-Olefin resins are propylene random copolymers or propylene block copolymers obtained by copolymerizing propylene and at least two comonomers selected from α-olefins having from 4 to 20 carbon atoms. These propylene random copolymers have α-olefin randomly bonded to the propylene chain. These propylene random copolymers may additionally contain ethylene.

As the α-olefins, α-olefins having from 4 to 20 carbon atoms are exemplified, e.g., 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene are exemplified. Of these α-olefins, 1-butene, 1-pentene, 1-hexene and 1-octene are preferred, and 1-butene and 1-hexene are more preferred in view of copolymerization property and economical efficiency.

As the propylene random copolymers for use in the present invention, e.g., propylene-1-butene random copolymer, propylene-1-hexene random copolymer, propylene-ethylene-1-butene random copolymer, and propylene-ethylene-1-hexene random copolymer are exemplified, and propylene-1-butene random copolymer and propylene-ethylene-1-butene random copolymer are preferably used.

When the propylene random copolymer for use in the present invention is a random copolymer of propylene and α-olefin , the α-olefin content is preferably from 11.5 to 25.0 mol % from the standpoint of the heat sealability at low temperature or the stable production of the random copolymer, and more preferably from 14.0 to 20.0 mol %.

When the propylene random copolymer for use in the present invention is a random copolymer of propylene, ethylene and α-olefin , the total content of ethylene and α-olefin is preferably from 2.0 to 35 mol % in view of the heat sealability at low temperature or the hood hygiene, more preferably from 6.5 to 26 mol %, and especially preferably from 8 to 23 mol %.

The propylene block copolymers described in the specification of the present invention are propylene block copolymers comprising a copolymer part (X part) in which a repeating unit derived from propylene (hereinafter referred to as “a propylene repeating unit”)., a repeating unit derived from ethylene (hereinafter referred to as “an ethylene repeating unit”), and/or a repeating unit derived fromα-olefin (hereinafter referred to as “an α-olefin repeating unit”) are randomly bonded, and a copolymer part (Y part) in which a propylene repeating unit, an ethylene repeating unit, and/or an α-olefin repeating unit are randomly bonded, and each repeating unit in Y part has structure different from each repeating unit in X part.

As the α-olefin s having from 4 to 20 carbon atoms for use in the invention, the above shown α-olefin s are exemplified. As the propylene block copolymers for use in the invention, (propylene-ethylene)-(propylene-ethylene) block copolymer, (propylene-ethylene)-(propylene-1-butene) block copolymer, (propylene-1-butene)-(propylene-ethylene) block copolymer, (propylene-1-butene)-(propylene-1-butene) block copolymer, (propylene-1-butene)-(propylene-ethylene-1-butene) block copolymer, (propylene-ethylene)-(propylene-ethylene-1-butene) block copolymer, (propylene-ethylene-1-butene)-(propylene-ethylene) block copolymer, and (propylene-ethylene-1-butene)-(propylene-ethylene-1-butene) block copolymer are exemplified, preferably (propylene-ethylene)-(propylene-ethylene) block copolymer, (propylene-ethylene)-(propylene-ethylene-1-butene) block copolymer, and (propylene-1-butene)-(propylene-ethylene-1-butene) block copolymer are exemplified.

The propylene block copolymers preferably used in the present invention are propylene block copolymers comprising X part, a copolymer part, which contains a propylene repeating unit and an ethylene repeating unit, and may contain an α-olefin repeating unit, and Y part, a copolymer part, which has a structure different from that of X part and contains a propylene repeating unit and an ethylene repeating unit, and may contain an α-olefin repeating unit.

In the case where X part of the propylene block copolymers for use in the present invention is a copolymer part that contains a propylene repeating unit and an ethylene repeating unit, and may contain an α-olefin repeating unit, the ethylene content is preferably from 2.0 to 9.0 mol % from the standpoint of the heat sealability at low temperature or the stable production of the propylene block copolymers, more preferably from 4.0 to 7.0 mol %, and the α-olefin content is preferably from 0 to 16.0 mol % in the light of transparency.

The content of X part in the propylene block copolymers for use in the present invention is preferably from 40 to 85 wt % from the standpoint of the heat sealability at low temperature or the stable production of the propylene block copolymers, more preferably from 45 to 80 wt %.

The content of Y part in the propylene block copolymers for use in the present invention is preferably from 15 to 60 wt % from the standpoint of the heat sealability at low temperature or the stable production of the propylene block copolymers, more preferably from 20 to 55 wt %.

The propylene block copolymers especially preferably used in the invention are propylene block copolymers in which X part is a copolymer part containing a propylene repeating unit (a main component) and an ethylene repeating unit, and Y part is a copolymer part having a structure different from that of X part and containing a propylene repeating unit (a main component) and an ethylene repeating unit.

The polyolefin waxes for use in the present invention are ethylene homopolymers or ethylene/α-olefin copolymers. As the α-olefin s, propylene, 1-butene, 1-pentene, 1-hexene, 4-methyl-1-pentene and 1-octene are exemplified, preferably propylene, 1-butene, 1-hexene and 4-methyl-1-pentene are used.

As the tackiness imparting resins for use in the present invention, rosins, alicyclic hydrogenated tackifiers, modified rosins, esterified products thereof, aliphatic petroleum resins, alicyclic petroleum resins, aromatic petroleum resins, copolymer petroleum resins comprising an aliphatic component and an aromatic component, terpene resins, low molecular weight styrene resins, alkylphenol resins and isoprene resins are exemplified, preferably rosins, rosin esters, petroleum resins and terpene resins are used. These tackiness imparting resins may be used alone or two or more in combination in the present invention.

Further, other known additives for resin can be arbitrarily added to the heat sealable resin layer (II) in the invention so long as they do not hinder the aiming heat sealability. As such additives, a dye, a nucleating agent, a plasticizer, a mold releasing agent, an antioxidant, a flame retardant and a UV absorber can be exemplified. The thickness of the heat sealable resin layer (II) is from 0.5 to 20 μm, preferably from 1 to 5 μm. The thickness of at least 1 μm is necessary so that the heat sealable resin layer (II) is melted in blow molding by the heat of molten polyethylene and molten polypropylene of parisons and a molded container and a label are firmly welded. When the thickness exceeds 5 μm, a label unfavorably curls and fixation of the label in a mold becomes difficult.

For preventing the occurrence of blisters in blow molding, the heat sealable resin layer of a label can be embossed as disclosed in JP-A-2-84319 and JP-A-3-260689. The emboss pattern is emboss process of from 5 to 200 line/54 cm, and reverse gravure pattern is preferred.

The mixing method of the constituents of the label in the present invention is not especially restricted and various known methods can be used, and mixing temperature and time are arbitrarily selected according to the properties of the components. Mixing in the state of being dissolved or dispersed in a solvent and melt kneading are exemplified, and melt kneading is good in productive efficiency. Methods of mixing a thermoplastic resin, inorganic fine powder, and/or organic filler and a dispersant in the states of powders and pellets with a Henschel mixer, a ribbon blender, a super-mixer, etc., melt kneading and extruding the components as a strand with a double kneading extruder and cutting to make pellets, and methods of extruding the components into water with a strand die and cutting with rotary blades equipped at the tip of the die are exemplified. Further, methods of once mixing a dispersant of powder, liquid, or in the state being dissolved in water or an organic solvent, with inorganic fine powder and/or organic filler, and then mixing with other components of thermoplastic resin are exemplified.

The in-mold label in the present invention can be manufactured by combining various methods known in the industry. Resin films manufactured by any methods are included in the scope of the present invention so long as the conditions described in the patents are satisfied.

The in-mold label in the invention can be manufactured by various known film-forming methods and combination thereof. For example, a cast molding method of extruding a molten resin in sheet with a single layer or multilayer T dies connected to a screw extruder, a stretched film-forming method utilizing void generation by stretching, a rolling method of generating voids in rolling and a calender molding method, a foaming method of using a foaming agent, a method of using void-containing particles, an inflation molding method, a solvent extraction method, and a method of dissolving and extracting mixed components are exemplified. Of these methods, a stretched film-forming method is preferably used.

Various well-known methods can be used in stretching. Stretching can be carried out at temperature higher than the glass transition temperature of the thermoplastic resin used in the case of amorphous resins, and in a proper temperature range from the glass transition temperature of the amorphous part to the melting point or lower of the crystalline part in the case of crystalline resins. Stretching can be performed by various methods, specifically, e.g., stretching in the machine direction utilizing difference in peripheral speeds of rolls, stretching in the transverse direction using a tenter oven, rolling, inflation stretching using mandrel to a tubular film, and simultaneous biaxial stretching by the combination of a tenter oven and a linear motor.

The magnifications of stretching are not especially restricted and arbitrarily determined considering the characteristics of the thermoplastic resins for use as the resin film of the object in the invention. For example, when a propylene homopolymer or copolymers thereof are used as the thermoplastic resin, stretching in one direction is generally from 1.2 to 12 times, preferably from 2 to 10 times, and biaxial stretching is generally from 1.5 to 60 times, preferably from 10 to 50 times. When other thermoplastic resins are used, stretching in one direction is generally from 1.2 to 10 times, preferably from 2 to 7 times, and biaxial stretching is generally from 1.5 to 20 times, preferably from 4 to 12 times.

If necessary, heat treatment at high temperature can be performed. The stretching temperature is lower than the melting point of the thermoplastic resin used by 2 to 160° C., and when a propylene homopolymer or a copolymer thereof is used as the thermoplastic resin, the stretching temperature is preferably lower by 2 to 60° C. than the melting point of the thermoplastic resin, and the stretching velocity is preferably from 20 to 350 m/min.

The printability of the surface of the thermoplastic resin film base layer (I) of the in-mold label in the invention can be improved beforehand by activation treatment, if necessary. The activation treatment is at least treatment selected from corona discharge treatment, flame treatment, plasma treatment, glow discharge treatment, and ozone treatment, preferably corona discharge treatment and flame treatment. The throughput in the case of corona discharge treatment is generally from 600 to 12,000 J/m² (from 10 to 200 W·min/m²), preferably from 1,200 to 9,000 J/m² (from 20 to 150 W·min/m²). When the throughput is 600 J/m² (10 W·min/m²) or more, the effect of corona discharge treatment can be sufficiently obtained, so that repelling does not occur in the subsequent coating of a surface modifier. Further, the effect of treatment reaches the ceiling when the throughput exceeds 12,000 J/m² (200 W·min/m²), so that the throughput of 12,000 J/m² (200 W·min/m²) or less is sufficient. The throughput in the case of flame treatment is generally from 8,000 to 200,000 J/m², preferably from 20,000 to 100,000 J/m². When 8,000 J/m² or more, the effect of flame treatment can be sufficiently obtained, so that repelling does not occur in the subsequent coating of a surface modifier. Further, the effect of treatment reaches the ceiling when the throughput exceeds 200,000 J/m², so that 200,000 J/m² or less is sufficient.

The void ratio of the label in the present invention is 10% or less, preferably from 0.01 to 10%, and more preferably from 0.1 to 5%. When the void ratio exceeds 10%, the transparency of the label is insufficient.

“Void ratio” in the present invention is a value computed according to the following equation (1). In equation (1), ρ0 represents true density, and ρ represents the density of a label of a stretched film (in conformity with JIS-K-7112). True density is almost equivalent to the density before stretching provided that the material before stretching does not contain a great quantity of air.
Void ratio(%)=100×(ρ0−ρ)/ρ0 (1)
(in the equation, ρ0: true density of the label, ρ: density of the label)

The opacity of the label in the present invention on the basis of JIS-P-8138 is 20% or less, preferably from 0.01 to 20%, and more preferably from 0.1 to 18%. When the opacity exceeds 20%, the transparency of the label is insufficient. The opacity in the present invention is a numerical value obtained by dividing the value measured by applying a black plate on the back of a sample with the value measured by applying a white plate on the back of the same sample in conformity with JIS-P-8138 and expressed in a percentage.

Printed matter containing a bar code, a manufacturer, a selling agency, a character, a trade name, usage and the like printed by gravure printing, offset printing, flexographic printing, screen printing, etc., can be used. A printed label is cut into a desired shape and size by punching. This label for in-mold molding may have such a size as to cover the surface of a container partly, but in general the label is manufactured as a blank for surrounding the side wall of a cup-like container, or as a label to be applied to the front and/or back sides of a bottle-like container by blow molding.

The label in the invention may have holes or slits.

When holes are formed on the label in the invention, the diameter of the hole is preferably from 0.05 to 1 mm, more preferably from 0.1 to 0.5 mm. The holes are preferably through holes having a pitch of from 5 to 30 mm. The method of punching is not especially restricted, but punching from the side of the label containing printed matter or the heat sealable layer side by means of a needle, an electron beam or a laser beam is preferred. For punching with a needle, not only a needle of circular cone but various needles of triangular, quadrangular, or more polygonal cones can be used.

The pattern of through holes is not especially restricted so long as the air permeability of the label can be adjusted to 10 to 20,000 sec.

When slits are formed on the label in the invention to adjust air permeability, the length of the slit is preferably from 0.5 to 20 mm, more preferably from 1 to 15 mm. The slits having a length less than 0.5 mm or exceeding 20 mm are liable to be insufficient in air permeability, in particular when the length exceeds 20 mm the slit is apt to cleave to thereby give a labeled molded product of resin deteriorated in external appearance. The relationship between the length of slits formed on a label and the pitch is not especially restricted, but it is in general necessary to make the pitch small when the length of slits is short, contrary to this the pitch is made large when the length of slits is long.

The slit lengths and pitches of a plurality of slits formed on a label may be respectively the same or different. For saving the production costs by the simplification of producing process of labels, it is effective to make the slit lengths and pitches of all the slits formed on a label the same.

The pattern of arrangement of slits formed on a label in the invention is not especially restricted but a label having a lattice-shaped pattern is preferred. A slit pattern may be the same one pattern as a label at large or a plurality of patterns may be present on a label.

In-Mold Molding:

The label for in-mold molding in the present invention is set in the cavity of a female mold, i.e., the lower mold half, of a differential pressure forming mold in such a manner that the print side of the label is in contact with the cavity wall. The label is then fixed to the inner surface of the mold wall by suction. A sheet of a molten resin material to form a container is placed over the lower female mold to perform differential pressure forming in a conventional way. As a result, a labeled container is molded in which the label has been fused to and united with the external surface of the container wall. Although the differential pressure forming may be either vacuum forming or air pressure forming, a combination of both is generally preferably carried out with a plug assist. The labels can be especially preferably used as the in-mold labels for blow molding of pressing a parison of a molten resin against the inner surface of a mold wall with air pressure. The labeled container thus produced is free from deformation of the label, has excellent adhesion between the container body and the label, and has a satisfactory decorative appearance with no blisters, because the label is fixed to the inner surface of the mold before being united with the resin container by integral molding.

Thermoplastic resin containers are preferred as the containers used in the present invention, it is more preferred to contain polyolefin resins, and the polyolefin resins are especially preferably polypropylene resins.

The present invention will be described in more detail below with reference to Production Examples, Examples and Test Examples. The materials, use amounts thereof, proportions, the contents and procedures of treatments can be arbitrarily changed without departing from the spirit and scope of the present invention.

Accordingly, the scope of the invention is not limited to the specific examples shown below. The degree of a non-crystallinity by a DSC at less than 90° C. in Production Examples, Examples and Comparative Examples was found with a DSC of model EXSTAR 6000 (manufactured by SII Nano Technology Inc.). A sample was taken in an amount of 5 mg and fused by raising the temperature from room temperature to 300° C. at a rate of 10° C./min. under nitrogen gas atmosphere of flow rate of 30 ml/min, held the temperature at 300° C. for 3 minutes, the temperature was then lowered to −60° C. at a rate of 10° C./min. to crystallize the sample, and then again fused by raising the temperature to 300° C. at a rate of 10° C./min. At this time the quantity of heat of fusion was measured and the degree of a non-crystallinity at less than 90° C. was found according to the following equation (1).
The degree of a non-crystallinity at less than 90° C.(%)=100−(the quantity of heat of fusion at 90° C. or more)/(the quantity of heat of fusion of a 100% crystal state) (1)

As the quantity of heat of fusion of a propylene resin in a 100% crystal state, the value of 209 J/g (J. Appl. Polym. Sci., 87, 916, 2003) was quoted, and as the quantity of heat of fusion of an ethylene resin, the value of 277 J/g (Polymer Handbook, Vo. 13, Fourth Edition) was quoted. The average surface roughness Ra was measured with a surface roughness meter (Surfcorder SE-30, manufactured by Kosaka Laboratory Ltd.). The value of MFR was obtained by the measurement in accordance with JIS-K-6760, the density was measured according to JIS-K-7112, and the opacity was according to JIS-P-8138.

### PRODUCTION EXAMPLE 1

### Production Example of Label (1)

Resin composition (A) (shown in Table 2 below) comprising 89 parts by weight of PP1 shown in Table 1 below, 10 parts by weight of HDPE shown in Table 1, and 1 part by weight of calcium carbonate shown in Table 1 was melt kneaded with an extruder, extruded in sheet through a die at 250° C., and the sheet was cooled to reach about 50° C. After heating again at about 150° C., the sheet was stretched 4 times in the machine direction utilizing the peripheral speeds of rolls, whereby a monoaxially stretched film was obtained.

Differently from the above, resin composition (B) (shown in Table 2) comprising 85 parts by weight of PP2 shown in Table 1, 5 parts by weight of HDPE and 10 parts by weight of calcium carbonate was melt kneaded with the extruder at 240° C., extruded in a sheet form through the die on the surface of the film stretched in the machine direction and laminated (B/A), whereby a laminate of surface layer/core layer was obtained.

Further, resin composition (C) (shown in Table 2) comprising 93 parts by weight of PP2, 5 parts by weight of HDPE, and 2 parts by weight of calcium carbonate was melt kneaded with a biaxial extruder at 200° C., extruded as a strand and cut.

Resin composition (C) and pellets for heat sealable resin layer (II-a) (shown in Table 2) comprising 100 parts by weight of αPP shown in Table 1 were melt kneaded at 230° C. respectively with different extruders, fed to a co-extrusion die and laminated to each other in the die. After that, the laminate (C/II) was extruded through the die in a film form at 230° C., and the resulting laminate film extruded through the die was extrusion-laminated on the side of A layer of the above laminate (B/A) for the surface layer/core layer in a manner so that the heat sealable resin layer (II) became outside.

The obtained sheet was heated at 120° C. and then passed through embossing rolls comprising a metal roll and a rubber roll (120 lines/inch, a reverse gravure type) to form on the heat sealable resin layer side an embossed pattern comprising lines at an interval of 0.21 mm.

The four-layer film (B/A/C/II-a) was introduced into a tenter oven, where the film was heated at 155° C. and then stretched 7 times in the transverse direction with a tenter. Subsequently, the stretched film was heated at 164° C. for thermal setting, cooled to 55° C., trimmed, and the surface layer (B layer) was subjected to corona discharge treatment at 50 W·min/m², whereby a stretched resin film of a four-layer structure having density of 0.91 g/cm³, and a thickness of 100 μm (B/A/C/II-a=30 μm/40 μm/25 μm/5 μm) was obtained. The average surface roughness (Ra) of the heat sealable layer (II-a) side of the film was 3.2 μm, and the opacity according to JIS-P-8138 was 16%. A label (1) was obtained by cutting the thus-obtained stretched resin film.

TABLE 1

| | | | | | Degree of Non- |
|---|---|---|---|---|---|
| | | | | Melting | crystallinity at |
| Compounding | | | Density | Point | Less Than 90° C. |
| Ingredient | Kind | Content | (g/cm³) | (° C.) | (%) |
| Thermo- | Propylene | Novatech PP FY4, a trade | 0.90 | 164 | 58 |
| plastic | homopolymer-1 | name, manufactured by Japan | | | |
| resin | (PP1) | Polypropylene Corporation, | | | |
| | | MFR (230° C., a load of 2.16 | | | |
| | | kg) = 5 g/10 min. | | | |
| | Propylene | Novatech PP MA3, a trade | 0.90 | 165 | — |
| | homopolymer-1 | name, manufactured by Japan | | | |
| | (PP2) | Polypropylene Corporation, | | | |
| | | MFR (230° C., a load of 2.16 | | | |
| | | kg) = 11 g/10 min. | | | |
| | High density | Novatech HD HJ580, a trade | 0.96 | 134 | — |
| | polyethylene | name, manufactured by Japan | | | |
| | (HDPE) | Polyethylene Corporation, | | | |
| | | MFR (190° C., a load of 2.16 | | | |
| | | kg) = 12 g/10 min. | | | |
| | α-Olefin- | Excellen SPX78J1, a trade | 0.89 | 127 | 79 |
| | containing | name, manufactured by | | | |
| | polypropylene | Sumitomo Chemical Co., Ltd. | | | |
| | copolymer | MFR (230° C., a load of 2.16 | | | |
| | (αPP) | kg) = 7 g/10 min. | | | |
| | α-Olefin- | Engage 8401, a trade name, | 0.89 | 76 | 100 |
| | containing | manufactured by Du Pont | | | |
| | ethylene | Dow Elastomers, | | | |
| | copolymer | MFR (190° C., a load of 2.16 | | | |
| | (αPE) | kg) = 30 g/10 min. | | | |
| | Low density | Novatech LD LJ902, a trade | 0.92 | 102 | 79 |
| | polyethylene | name, manufactured by Japan | | | |
| | (LDPE) | Polyethylene Corporation, | | | |
| | | MFR (190° C., a load of 2.16 | | | |
| | | kg) = 45 g/10 min. | | | |
| | Ethylene- | Novatech EVA LV372, a trade | 0.93 | 88 | 95 |
| | vinyl | name, manufactured by Japan | | | |
| | acetate | Polyethylene Corporation, | | | |
| | copolymer | MFR (190° C., a load of 2.16 | | | |
| | (EVA) | kg) = 15 g/10 min. | | | |
| Inorganic | Calcium | Heavy calcium carbonate | 2.7 | — | — |
| fine | carbonate | having average particle | | | |
| powder | (CaCO₃) | size: 1.0 μm, specific | | | |
| | | surface area: 22,000 cm²/g, | | | |
| | | Softon 2200, a trade name, | | | |
| | | manufactured by Bihoku | | | |
| | | Funka Kogyo Co., Ltd. | | | |

TABLE 2

| | | | | | | | | | Inorganic | |
|---|---|---|---|---|---|---|---|---|---|---|
| | | | | | | | | | Fine Powder | |
| | | | | | | | | | Calcium | Degree |
| | | Thermoplastic Resin | | | | | | | Carbonate | of Non- |
| | | | | High | α-Olefin- | α-Olefin- | Low | Ethylene- | Powder | crystal- |
| | | | | Density | Containing | Containing | Density | Vinyl | (particle | linity |
| | | Propylene | | Poly- | Propylene | Ethylene | Poly- | Acetate | size: 1.0 | State at |
| | | Homopolymer | | ethylene | Copolymer | Copolymer | ethylene | Copolymer | μm) | Less Than |
| | | (pt. by wt.) | | (pt. by wt.) | (pt. by wt.) | (pt. by wt.) | (pt. by wt.) | (pt. by wt.) | (pt. by wt.) | 90° C. |
| | | PP1 | PP2 | HDPE | αPP | αPE | LDPE | EVA | CaCo₃ | (%) |
| Resin | | 89 | — | 10 | — | — | — | — | 1 | — |
| composition (A) | | | | | | | | | | |
| Resin | | — | 85 | 5 | — | — | — | — | 10 | — |
| composition (B) | | | | | | | | | | |
| Resin | | — | 93 | 5 | — | — | — | — | 2 | — |
| composition (C) | | | | | | | | | | |
| Pellets | II-a | — | — | — | 100 | — | — | — | — | 79 |
| for Heat | II-b | — | — | — | 40 | 30 | 30 | — | — | 84 |
| Sealable | II-c | — | — | — | 70 | — | 30 | — | — | 79 |
| Resin Layer | II-d | 40 | — | — | 60 | — | — | — | — | 69 |
| (II) | II-e | 100 | — | — | — | — | — | — | — | 58 |
| | II-f | — | — | — | — | 70 | 30 | — | — | 92 |
| | II-g | — | — | — | — | 100 | — | — | — | 100 |
| | II-h | — | — | — | — | — | — | 100 | — | 95 |

### PRODUCTION EXAMPLE 2

### Production Example of Label (2)

A stretched resin film was obtained in the same procedure as in Production Example 1 except that pellets (II-b) for heat sealable resin layer (shown in Table 2) comprising 40 parts by weight of αPP, 30 parts by weight of αPE shown in Table 1 and 30 parts by weight of LDPE were melt kneaded with the biaxial extruder at 200° C., extruded through the die in a strand form, and the strand was cut. A label (2) was obtained by cutting the above prepared stretched resin film.

### PRODUCTION EXAMPLE 3

### Production Example of Label (3)

A stretched resin film was obtained in the same procedure as in Production Example 1 except that pellets (II-c) for heat sealable resin layer (shown in Table 2) comprising 70 parts by weight of αPP and 30 parts by weight of LDPE were melt kneaded with the biaxial extruder at 200° C., extruded through the die in a strand form, and the strand was cut. A label (3) was obtained by cutting the above prepared stretched resin film.

### PRODUCTION EXAMPLE 4

### Production Example of Label (4)

A stretched resin film was obtained in the same procedure as in Production Example 1 except that pellets (II-d) for heat sealable resin layer (shown in Table 2) comprising 40 parts by weight of PP1 and 60 parts by weight of αPP were melt kneaded with the biaxial extruder at 200° C., extruded through the die in a strand form, and the strand was cut. A label (4) was obtained by cutting the above prepared stretched resin film.

### PRODUCTION EXAMPLE 5

### Production Example of Label (5)

A stretched resin film was obtained in the same procedure as in Production Example 1 except that pellets (II-e) for heat sealable resin layer (shown in Table 2) comprising 100 parts by weight of PP1 were melt kneaded with the biaxial extruder at 200° C., extruded through the die in a strand form, and the strand was cut. A label (5) was obtained by cutting the above prepared stretched resin film.

### PRODUCTION EXAMPLE 6

### Production Example of Label (6)

A stretched resin film was obtained in the same procedure as in Production Example 1 except that pellets (II-f) for heat sealable resin layer (shown in Table 2) comprising 70 parts by weight of αPE and 30 parts by weight of LDPE were melt kneaded with the biaxial extruder at 200° C., extruded through the die in a strand form, and the strand was cut. A label (6) was obtained by cutting the above prepared stretched resin film.

### PRODUCTION EXAMPLE 7

### Production Example of Label (7)

A stretched resin film was obtained in the same procedure as in Production Example 1 except that pellets (II-g) for heat sealable resin layer (shown in Table 2) comprising 100 parts by weight of αPE were melt kneaded with the biaxial extruder at 200° C., extruded through the die in a strand form, and the strand was cut. A label (7) was obtained by cutting the above prepared stretched resin film.

### PRODUCTION EXAMPLE 8

### Production Example of Label (8)

A stretched resin film was obtained in the same procedure as in Production Example 1 except that pellets (II-h) for heat sealable resin layer (shown in Table 2) comprising 100 parts by weight of EVA shown in Table 1 were melt kneaded with the biaxial extruder at 200° C., extruded through the die in a strand form, and the strand was cut. A label (8) was obtained by cutting the above prepared stretched resin film.

### EXAMPLES 1 TO 4 AND COMPARATIVE EXAMPLES 1 TO 4

Monolayer resin containers in Examples 1 to 4 and Comparative Examples 1 to 4 were formed using, as the materials for forming containers, a propylene homopolymer (Novatech PP “EG8” having a melt flow rate of 0.7 g/10 min at 230° C. and a load of 2.16 kg, manufactured by Japan Polypropylene Corporation), a 3 liter-mold for container, and a large size direct blow mold (TPF-706B, manufactured by Tahara Machinery Ltd.). Containers were molded by performing control of a parison by the temperature of the parison of 200° C., the temperature of cooling water of the mold of 5° C., and the intervals of die lips were adjusted with the weight of an empty container of 140 g. The label was applied on the container so that the direction of the eyelets of the label and the spout/bottom of the container were in parallel.

Each label shown in Table 3 below was inserted into the barrels of the inner walls in both split-mold cavities with an automatic inserter, fixed by suction in the mold, and a labeled resin container was manufactured by in-mold molding.

The obtained container was evaluated for the occurrence of blisters as practicability. The evaluation was performed on the basis of the following criteria. The evaluation was performed each for 10. The results obtained are shown in Table 3 below.
⊚: A Blister of from 0 to 1/10 generated (practicable level).
◯: Blisters of from 2 to 3/10 generated (practicable level).
×: Blisters of from 4 to 7/10 generated (impracticable level).
××: Blisters of from 8 to 10/10 generated (impracticable level).

In the above practicability evaluation of the occurrence of blisters, each resin container that was evaluated as practicable was filled with hot water of 90° C. to the spout, and the hot water was squeezed 30 seconds after to evaluate hot fill suitability. The evaluation was performed on the basis of the following criteria. The results obtained are shown in Table 3.
⊚: The label did not peel or did not misalign after squeezing (practicable level).
◯: The label peeled a little but did not misalign after squeezing (practicable level).
×: The label got out of position after squeezing (impracticable level).

××: The label peeled after squeezing (impracticable level).

TABLE 3

| | | | Example | | | | Comparative Example | | | |
|---|---|---|---|---|---|---|---|---|---|---|
| Item of Evaluation | | Unit | 1 | 2 | 3 | 4 | 1 | 2 | 3 | 4 |
| Label | Adhered label | — | Label (1) | Label (2) | Label (3) | Label (4) | Label (5) | Label (6) | Label (7) | Label (8) |
| | Pellets for heat | — | II-a | II-b | II-c | II-d | II-e | II-f | II-g | II-h |
| | sealable resin layer | | | | | | | | | |
| | Thickness | μm | 100 | 100 | 100 | 100 | 100 | 100 | 100 | 100 |
| | Density | g/cm³ | 0.91 | 0.91 | 0.91 | 0.91 | 0.91 | 0.91 | 0.91 | 0.91 |
| | Void ratio | % | 1 | 1 | 1 | 1 | 1 | 1 | 1 | 1 |
| | Opacity | % | 16 | 16 | 16 | 16 | 16 | 16 | 16 | 16 |
| | Average surface | mm | 3.2 | 2.8 | 3.2 | 3.2 | 3.2 | 2.8 | 2.5 | 2.5 |
| | roughness Ra on the | | | | | | | | | |
| | side of heat sealable | | | | | | | | | |
| | layer | | | | | | | | | |
| Evaluation of | Restraint of blister | — | ⊚ | ⊚ | ⊚ | ◯ | XX | ⊚ | ⊚ | ⊚ |
| practicability | in large size direct | | | | | | | | | |
| | blow molding | | | | | | | | | |
| | Hot fill suitability | — | ⊚ | ◯ | ⊚ | ⊚ | — | XX | XX | XX |

The present invention can provide a labeled resin container that is restrained in the occurrence of blisters on the in-mold molding conditions of low temperature cooling, and also provide a label for use in in-mold molding high in adhesion to the container even by filling with high temperature contents.

While the invention has been described in detail and with reference to specific examples thereof, it will be apparent to one skilled in the art that various changes and modifications can be made therein without departing from the spirit and scope thereof.

What is claimed is:

1. A label for in-mold molding, having a porosity of 10% or less and an opacity (in conformity with JIS-P-8138) of 20% or less, and comprising a thermoplastic resin film base layer (I) and a heat sealable resin layer (II), wherein the heat sealable resin layer (II) has the degree of a non-crystallinity of from 60 to 90% measured with a differential scanning calorimeter (DSC) at less than 90° C., and contains a copolymer of propylene and α-olefin having from 4 to 20 carbon atoms.

2. The label for in-mold molding as claimed in claim 1, wherein the heat sealable resin layer (II) has the degree of a non-crystallinity of from 65 to 90% measured with a DSC at less than 90° C.

3. The label for in-mold molding as claimed in claim 1, wherein a material of a container as an adherend contains a polyolefin resin.

4. The label for in-mold molding as claimed in claim 3, wherein the polyolefin resin is a polypropylene resin.

5. The label for in-mold molding as claimed in claim 1, which comprises the heat sealable resin layer (II) on one side of the thermoplastic resin film base layer (I), and is labeled on a container through the heat sealable resin layer (II).

6. The label for in-mold molding as claimed in claim 5, wherein the thermoplastic resin film base layer (I) is a monoaxially stretched layer.

7. The label for in-mold molding as claimed in claim 5, wherein the thermoplastic resin film base layer (I) is a biaxially stretched layer.

8. The label for in-mold molding as claimed in claim 5, wherein the thermoplastic resin film base layer (I) comprises a biaxially stretched layer and a monoaxially stretched layer.

9. The label for in-mold molding as claimed in claim 5, wherein the heat sealable resin layer (II) is a layer that is at least a monoaxially stretched.

10. The label for in-mold molding as claimed in claim 5, wherein the heat sealable resin layer (II) is embossed.

11. The label for in-mold molding as claimed in claim 5, wherein the heat sealable resin layer (II) is formed by coating.

12. The label for in-mold molding as claimed in claim 5, wherein a peel-off and misalignment of the label do not occur when a container with the label is filled with a content of 90° C.

13. The label for in-mold molding as claimed in claim 1, which has at least one of holes and slits.

14. A labeled resin container, which is labeled with the label for in-mold molding as claimed in claim 1.

15. The labeled resin container as claimed in claim 14, which is a polypropylene resin container.

16. A method for producing the label for in-mold molding as claimed in claim 1.

17. A method for producing the labeled resin container as claimed in claim 14.
